(19) United States
(12) Patent Application Publication
(10) Pub. No.: US 2014/0048988 A1
(43) Pub. Date: Feb. 20, 2014

(54) LEAF SPRING ASSEMBLY

(71) Applicants: Peter J. Soles, Tecumseh (CA); Jian Chen, West Bloomfield, MI (US)

(72) Inventors: Peter J. Soles, Tecumseh (CA); Jian Chen, West Bloomfield, MI (US)

(73) Assignee: GM GLOBAL TECHNOLOGY OPERATIONS LLC, Detroit, MI (US)

(21) Appl. No.: 13/585,880

(22) Filed: Aug. 15, 2012

(51) Int. Cl. F16F 1/368; B60G 11/113; B60G 11/02

(52) U.S. Cl. 267/36.1

(57) ABSTRACT

A leaf spring assembly includes a main stage and a second stage. The main stage has at least one leaf, which is a steel leaf. The second stage has a composite leaf. The second stage is operatively attached to, and aligned with, the main stage.

### TECHNICAL FIELD

This disclosure relates to leaf springs and leaf spring assembly, such as those used in vehicular suspensions.

### BACKGROUND

Leaf springs and leaf spring assemblies usually refer to either a simple beam used as a spring or laminations of beams used as a spring. Leaf springs are formed from one or more leaves, which are often slightly arched bands. An axle, or other unsprung component, is suspended from the leaf spring. The bending of the leaves provides a cushioning effect.

### SUMMARY

A leaf spring assembly—which may be attached to a vehicle, such as to an axle and suspended components, is provided. The leaf spring assembly includes a main stage and a second stage. The main stage has at least one leaf, which is a steel leaf. The second stage has a composite leaf. The second stage is operatively attached to, and aligned with, the main stage. Relative to the main stage, the composite leaf may have positive curvature.

The above features and advantages, and other features and advantages, of the present invention are readily apparent from the following detailed description of some of the best modes and other embodiments for carrying out the invention, which is defined solely by the appended claims, when taken in connection with the accompanying drawings.

### BRIEF DESCRIPTION OF THE DRAWINGS

FIG. 1 is a schematic, isometric view of a leaf spring assembly for a vehicle;

FIG. 2 is a schematic, side view of the leaf spring assembly shown in FIG. 1;

FIG. 3 is a schematic, side view of the leaf spring assembly shown in FIGS. 1-2, with the leaf spring assembly subjected to further loading;

FIG. 4 is a schematic, top view of a second stage of the leaf spring assembly of FIGS. 1-3;

FIG. 5 is a schematic, side view of the second stage of the leaf spring assembly shown in FIGS. 1-3;

FIG. 6 is a schematic, cross-sectional view taken along a line 6-6 of FIG. 5; and

FIG. 7 is a schematic, cross-sectional view taken along a line 7-7 of FIG. 5.

### DETAILED DESCRIPTION

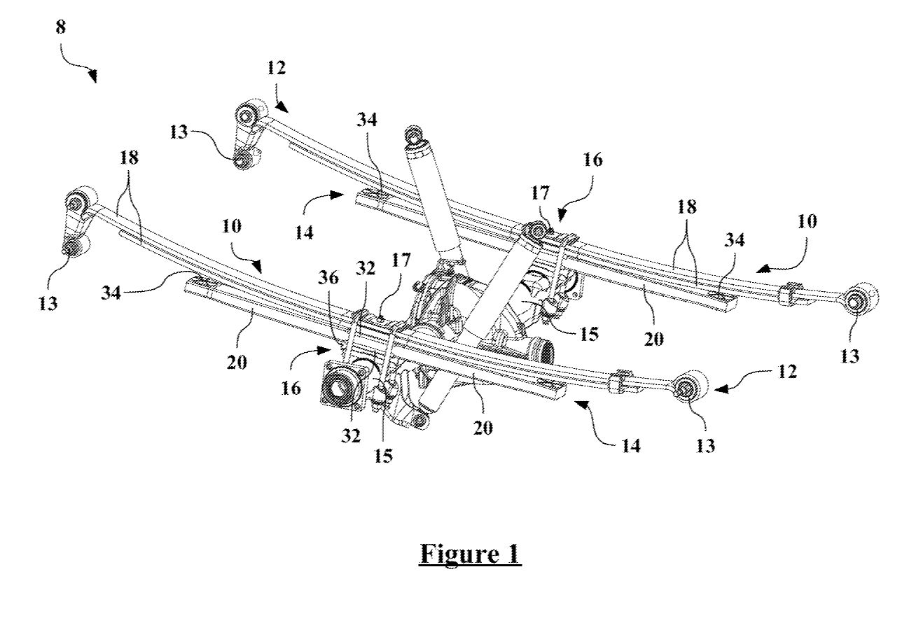

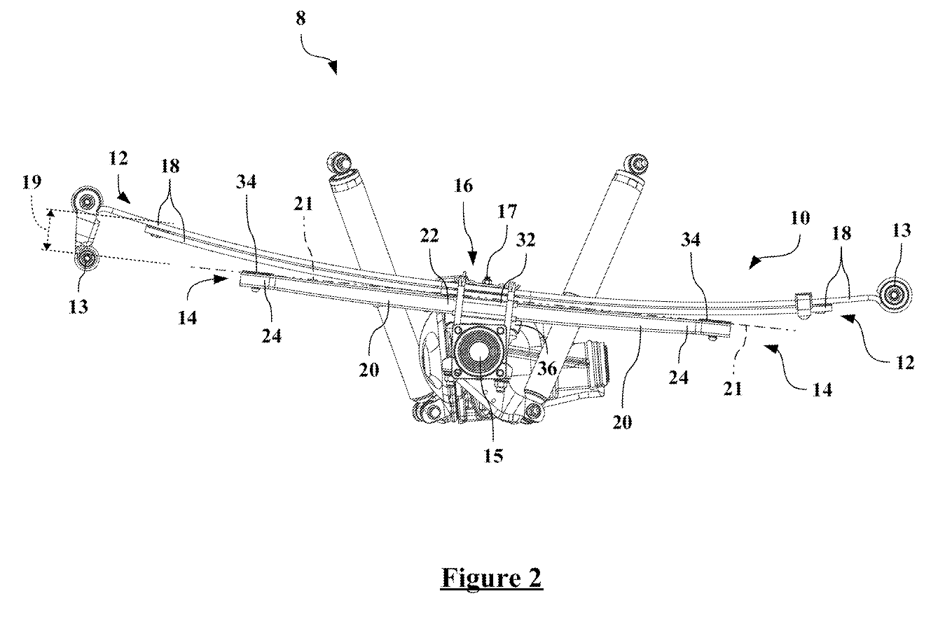

Referring to the drawings, like reference numbers correspond to like or similar components wherever possible throughout the several figures. In FIG. 1 and FIG. 2, there are shown schematic views of a suspension assembly 8 having one or more leaf spring assemblies 10. FIG. 1 shows an isometric view of two leaf spring assemblies 10 within the suspension assembly 8, and FIG. 2 shows a side view of the suspension assembly 8. The suspension assembly 8 may be only a portion of the suspension system for a vehicle (not shown).

While the present invention may be described with respect to automotive or vehicular applications, those skilled in the art will recognize the broader applicability of the invention. Those having ordinary skill in the art will recognize that terms such as “above,” “below,” “upward,” “downward,” et cetera, are used descriptively of the figures, and do not represent limitations on the scope of the invention, as defined by the appended claims. Any numerical designations, such as “first” or “second” are illustrative only and are not intended to limit the scope of the invention in any way.

As shown in the figures, each leaf spring assembly 10 includes a main stage 12, which attaches to the vehicle at a plurality of vehicle attachment points 13. The leaf spring assemblies also include a second stage 14, which is not directly attached to the vehicle. The leaf spring assembly 10 suspends an axle 15. A mounting apparatus 16, including a center bolt 17, joins the second stage 14 to the main stage 12, and also joins the leaf spring assembly 10 to the axle 15. The mounting apparatus 16 may also be referred to as a U-bolt assembly or U-clamp. Alternatively, the mounting apparatus 16 may join the leaf spring assembly 10 to, for example, a half-shaft or a knuckle (neither of which are shown). The mounting assembly 16 provides clamping force between the axle 15 and both the main stage 12 and the second stage 14.

The main stage 12 is shown with at least two leaves, which are steel leaves 18. The main stage 12 attaches to the vehicle at the vehicle attachment points 13, which may be attached directly to the steel leaves 18—such as through eyelets and bushings—or may be attached through a swing arm, shackle, or hook. In some configurations, the main stage 12 may have only a single steel leaf 18.

The second stage 14 has one leaf, which is a composite leaf 20. Flexure of the steel leaves 18 and the composite leaf 20, when engaged, provides suspension for between the vehicle and the axle 15 and wheels (not shown).

In the leaf spring assembly 10, the composite leaf 20 of the second stage 14 has a positive curvature relative to the main stage 12. As illustrated by a reference line 21, which is shown in FIG. 2 and is substantially tangent to the main stage 12 at the mounting apparatus 16, the positive curvature causes a center 22 of the composite leaf 20 to be lower (as viewed in the figure) than the distal ends 24 of the composite leaf 20.

As used herein, positive curvature of the composite leaf 20 relative to the main stage 12 refers to the composite leaf 20 having concavity toward the main stage 12, such that the distal ends 24 point toward the main stage 12, and the radius of the composite leaf 20 points toward the main stage 12. In FIG. 2, the centers of curvature of the composite leaf 20 and of the steel leaves 18 are above the main stage 12 (at least until the main stage 12 flexes sufficiently to flatten). As used regarding the curvature of the composite leaf 20 and the steel leaves 18, the term radius may refer to the center of curvature of shapes that are, for example: cylindrical, elliptical, hyperbolic, combinations thereof, or other curvatures.

Alternatively stated, positive curvature refers to the distal ends 24 being nearer, in a direction of travel of the suspension system 8, to the vehicle attachment points 13 than the center 22. The direction of travel of the suspension system 8 is generally upward and downward, as viewed in FIG. 2, and may be viewed as the vehicle attachment points 13 moving downward or the axle 15 moving upward.

Therefore, during engagement or loading of the composite leaf 20, the distal ends 24 of the composite leaf 20 will contact the main stage 12 at lower loads, when compared to an equivalent composite leaf 20 that does not have positive curvature. The positive curvature also places the distal ends 24 closer to the vehicle attachment points 13 of the main stage 12 than a flat, non-positively curved composite leaf 20.

In embodiments or configurations without positive curvature of the composite leaf 20 relative to the main stage 12, the composite leaf 20 may be flat, such that the center 22 and the distal ends 24 would all be substantially even with the reference line 21. Alternatively, the composite leaf 20 may curve away from the main stage 12, such that the distal ends 24 would be below the reference line 21.

The leaf spring assembly 10 is illustrated in FIGS. 1 and 2 with the vehicle at curb weight. The exact flexure or state of the leaf spring assembly 10 shown in the figures is illustrative only. The curb weight generally includes the total weight of the vehicle with standard equipment, all necessary operating consumables (such as motor oil and coolant), and a full tank of fuel, but not loaded with cargo.

The state of the leaf spring assembly 10 and the suspension assembly 8 shown in FIGS. 1 and 2 may alternatively be referred to as a neutral state or a first loading condition or state. Note that some definitions of curb weight vary, and that some include a predetermined driver mass and some include a constant amount of fuel, as opposed to a full tank.

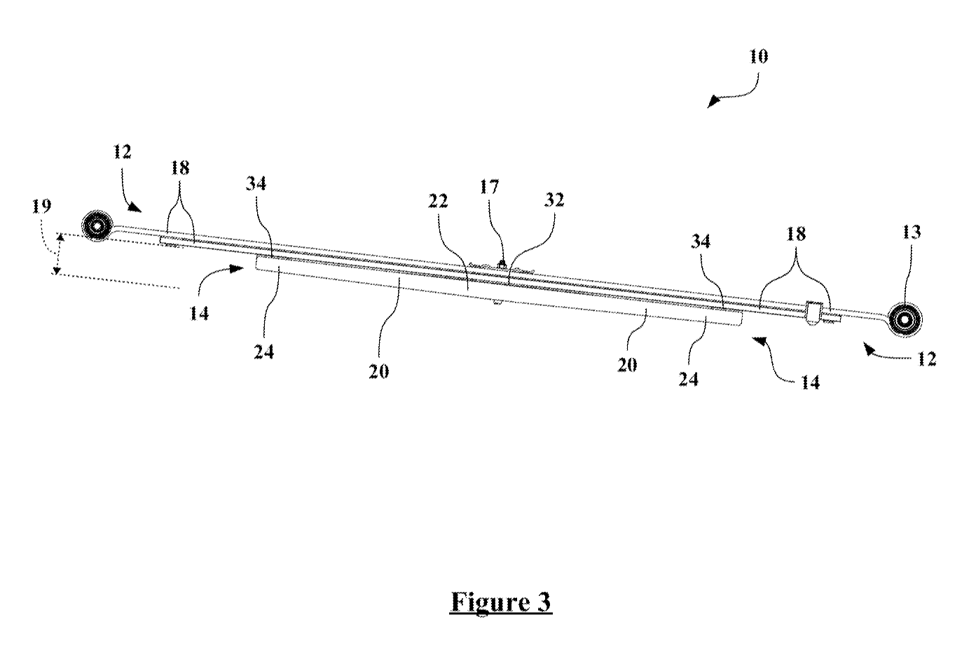

Referring also to FIG. 3, and with continued reference to FIGS. 1-2, there is shown another view of the leaf spring assembly 10. In FIG. 3, the leaf spring assembly 10 is illustrated with further loading on the suspension assembly 8, such that the leaf spring assembly 10 is shown in a second loading condition. As the vehicle is further loaded (either by additional cargo or introduction of forces from the road) the axle 15 travels upward relative to the vehicle attachment points 13. Alternatively stated, the vehicle and the vehicle attachment points 13 move downward relative to the axle 15 and the road upon which the vehicle is riding.

When the leaf spring assembly 10 shown in the figures is in its fully-loaded state, as generally illustrated in FIG. 3, the main stage 12 is substantially flat and the steel leaves 18 have little or no curvature. The fully-loaded state may be referred to as gross vehicle weight or a second loading state or condition. At, or near, this fully-loaded state, the main stage 12 has traveled over an engagement distance 19 and the second stage 14 comes into contact with the main stage 12.

After the main stage 12 travels the engagement distance 19, and the second stage 14 engages with the main stage 12. As the second stage 14 engages with the main stage 12, the spring rate of the leaf spring assembly 10 increases, and does so very quickly, as the composite leaf 20 contributes to carrying vehicle loads. Contact between the second stage 14 and the main stage 12, even when the main stage 12 is just short of flat, is promoted by the positive curvature of the composite leaf 20.

Referring also to FIG. 4, and with continued reference to FIGS. 1-3, there is shown a top view of the composite leaf 20. The composite leaf 20 has a first width 23 at the center 22, and a second width 25 at one of the distal ends 24. In the composite leaf 20, both distal ends 24 have substantially the same width. The second width 25 is greater than the first width 23, such that the composite leaf 20 widens at the distal ends 24 compared to the center 22.

As shown in FIGS. 1-4, the leaf spring assembly 10 includes a center spacer 32 disposed between the center 22 of the second stage 14 and the main stage 12. A load distribution spacer 36 is disposed between the axle 15 and the composite leaf 20 and is configured to spread and distribute loads applied by the mounting apparatus 16 and the center bolt 17 to the composite leaf 20.

The composite leaf 20 is formed from composite materials that may be softer than the metallic components of the mounting apparatus 16 and the center bolt 17. The load distribution spacer 36 may prevent damage, such as from the head of the center bolt 17 or the clamping force of the mounting apparatus 16, to the composite leaf 20. In the leaf spring assembly 10 shown, there is another center spacer 32 disposed between the second stage 14 and the load distribution spacer 36.

The leaf spring assembly 10 also includes a plurality of end spacers 34 disposed on the distal ends 24 of the second stage 14. The end spacers 34 are between the main stage 12 and the second stage 14.

Contact between the second stage 14 and the main stage 12, even when the main stage 12 is just short of flat, is promoted by the positive curvature of the composite leaf 20. Additionally, the end spacers 34 contribute to ensuring that the contact is made at the distal ends 24 of the composite leaf 20 instead of intermediate points between the center 22 and the distal ends 24. The portions of the composite leaf 20 that are between the center 22 and the distal ends 24 will remain spaced apart from the steel leaves 18 during engagement.

When the leaf spring assembly 10 flexes under increased loading of the vehicle, the composite leaf 20 of the second stage 14 engages with the main stage 12 at the end spacers 34 instead of near the center 22 of the composite leaf 20. The center 22 of the composite leaf 20 is also reacting against the mounting apparatus 16. As the leaf spring assembly 10 is loaded, the axle 15 moves upward (as viewed in FIGS. 1-3), relative to the vehicle attachment points 13, and the main stage 12 begins to flatten (i.e. loses its curvature). As illustrated in FIG. 3 the second stage 14 engages when the main stage 12 is sufficiently flat to cause the end spacers 34 to contact with the main stage 14. Engagement of the second stage 14 adds spring force between the axle 15 and the vehicle attachment points 13.

The end spacers 34 provide protection between the distal ends 24 of the second stage 14 and the main stage 12. Furthermore, the end spacers 34 extend the second stage 14 toward the main stage 12 to facilitate engagement of the second stage 14 with the main stage 12 at the distal ends 24. The end spacers 34 may shorten the engagement distance 19 needed to engage the second stage 14 with the main stage 12, or the end spacers 34 may allow the composite leaf 20 to have reduced curvature toward the main stage 12.

In the configuration shown, the end spacers 34 are sized to contact the main stage 12 just as the steel leaves 18 become flat (at gross vehicle weight or dynamic road loads causing equivalent travel in the suspension system 8). Further loads to the leaf spring assembly 10 cause the steel leaves 18 and the composite leaf 20 to flex beyond flat and into curvature opposite to that shown in FIGS. 1 and 2, until the suspension system 8 reaches a maximum flexure, such as by hitting a bump stop or contacting a portion of the chassis. As the leaf spring assembly 10 goes beyond flat, upper surfaces of the steel leaves 18 are placed into tension and lower surfaces remain in compression. The composite leaf 20 will flex into negative curvature as the leaf spring assembly 10 flexes beyond flat.

In some configurations of the second stage 14, the end spacers 34 could be integral to the distal ends 24 of the composite leaf 20 such that the end spacers 34 would not be removable from the composite leaf 20. Therefore, the end spacers 34 may be bosses formed into the distal ends 24 of the composite leaf 20, such that the end spacers and the composite leaf 20 form a unitary, one-piece component.

The leaf spring assembly 10 does not undergo rolling-engagement between the second stage 14 and the main stage 12 as the leaf spring assembly 10 flexes. In rolling-engagement, the composite leaf 20 would engage with the steel leaves 18 at the center 22 of the composite leaf 20 and then contact would roll outward toward the distal ends 24. Rolling-engagement has the effect of progressively engaging the second stage 14. However, without rolling-engagement, the leaf spring assembly 10 limits wearing or rubbing between the composite leaf 20 and the adjacent steel leaf 18 of the main stage 12.

The end spacers 34 may be formed from suitable rubber or plastic. The center spacers 32 and the end spacers 34 may be formed from, for example and without limitation: thermoplastic elastomer, thermoplastic polyester elastomer, or nylon. Note that the center spacer 32 is always in contact with the main stage 12 and may be under compression regardless of the loading state of the leaf spring assembly 10. However, the second stage 14 does not contribute spring forces to the leaf spring assembly 10 until the distal ends 24 of the composite leaf 20 engage with the main stage 12.

In some configurations, the composite leaf 20 may be substantially flat or have negative curvature opposite to the positive curvature shown. In those configurations, the thickness of the center spacer 32 may be reduced and the thickness of the end spacers 34 may be increased to ensure that the distal ends 24 of the composite leaf 20 engage with the main stage 12 first.

For example, in configurations having a substantially-flat composite leaf 20—such that the reference line 21 touches the center 22 and the distal ends 23 on substantially the same faces—the end spacers 34 could be thicker than the center spacer 32 to ensure that the distal ends 24 engage before the center 22 of the composite leaf 20. In configurations in which the composite leaf 20 curves away from the main stage 12—i.e., the composite leaf 20 has convex curvature toward the main stage 12, and its radius points away from the main stage 12—the composite leaf 20 will not engage with the main stage 12 until the steel leaves 18 have flexed beyond flat and begin to curve in the opposing direction to that shown in FIG. 2.

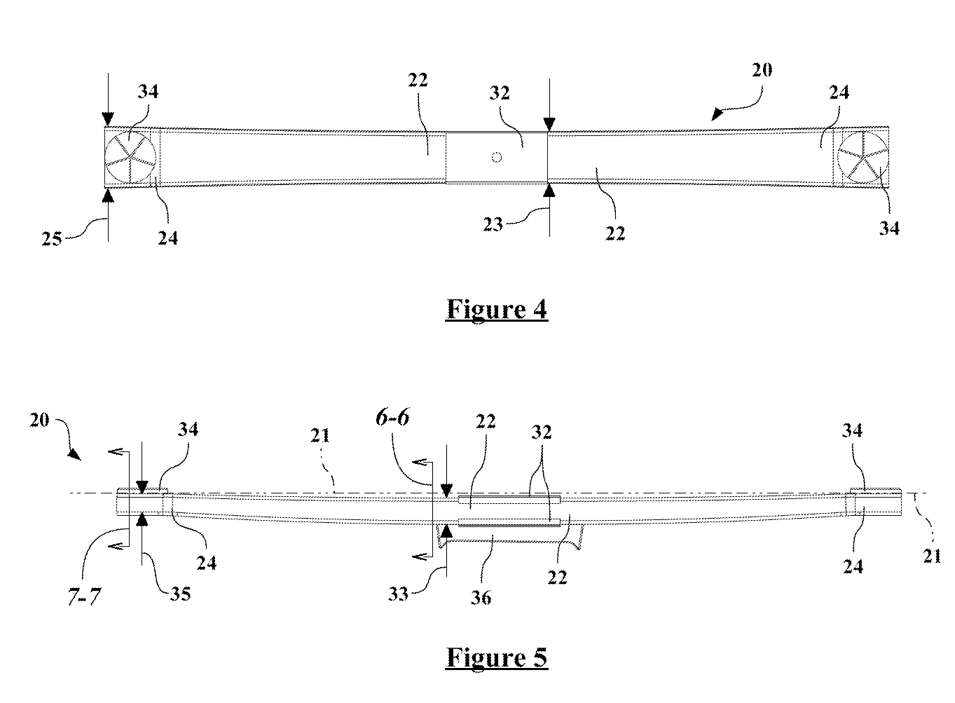

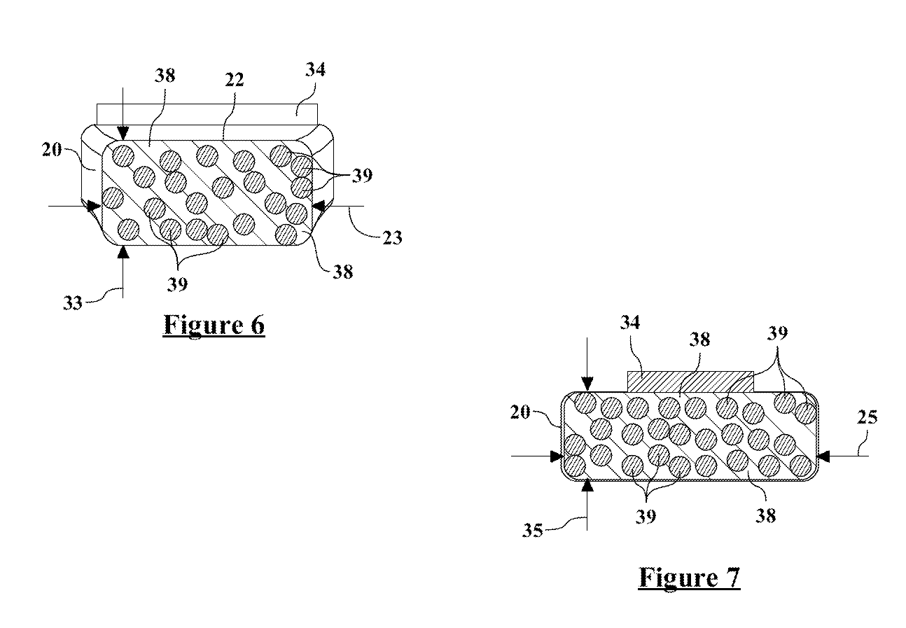

Referring now to FIG. 5, FIG. 6, and FIG. 7, and with continued reference to FIGS. 1-4, there are shown three views of the composite leaf 20. FIG. 5 shows a side view of only the composite leaf 20. Unlike the view of FIG. 4, the center spacer 32 and the end spacers 34 are not shown in FIG. 5.

FIG. 6 shows a cross-sectional view taken along a line 6-6 of FIG. 5, which is generally at the center 22 of the composite leaf 20. FIG. 7 shows a cross-sectional view taken along a line 7-7 of FIG. 5, which is generally at one of the distal ends 24 of the composite leaf 20.

The composite leaf 20 has a first thickness 33 at the center 22 and a second thickness 35 at the ends 24. The first thickness 33 is greater than the second thickness 35. Decreasing thickness from the center 22 to the ends 24 may provide an improved bending profile.

The composite leaf 20 of the leaf spring assembly 10 has a first cross-sectional area at the center 22 of the composite leaf 20, and a second cross-sectional area at the distal end 24 of the composite leaf 20. As shown in FIGS. 6 and 7, the first cross-sectional area at the center 22 and the second cross-sectional area at the distal end 24 are substantially equal. The composite leaf 20 has substantially-constant cross-sectional area at all lateral planes along the composite leaf 20. Alternatively stated, at any planer section, the first width 23 multiplied by the first thickness 33 is substantially equal to the second width 25 multiplied by the second width 37.

In configurations with substantially-constant cross-sectional areas, such as that shown in the figures, the composite leaf 20 also has substantially-constant density along its longitudinally length. Therefore, the center 22 and the distal ends 24 have substantially equal mass.

As shown in FIGS. 6 and 7, the composite leaf 20 of the second stage 14 may be formed from a resin matrix 38 and a plurality of fibers 39. In the configuration shown, the fibers 39 are substantially longitudinally-oriented along the composite leaf 20. Note that the size of the fibers 39 may be exaggerated in FIGS. 6 and 7 to better illustrate this specific configuration between the resin matrix 38 and the fibers 39. Alternatively, layers of the fibers 39 may be oriented at angles to each other. For example, the fibers 39 may be formed from carbon cloth laid in a forty-five, zero, negative forty-five degree lay-up arrangement.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A leaf spring assembly, comprising:
a main stage having at least two leaves, wherein the at least two leaves are steel leaves; and
a second stage operatively attached to the main stage and having a composite leaf, wherein the composite leaf is longitudinally aligned with the steel leaves of the main stage.

2. The leaf spring assembly of claim 1, wherein the composite leaf of the second stage has a positive curvature relative to the main stage.

3. The leaf spring assembly of claim 2,
wherein the second stage is operatively attached to the main stage at a center of the second stage,
wherein distal ends of the second stage are spaced apart from the main stage when the leaf spring assembly is in a first loading condition, and
wherein the positive curvature places the distal ends of the second stage in contact with the main stage when the leaf spring assembly is in a second loading condition in which the main stage traveled toward the second stage by an engagement distance, and portions of the second stage between the distal ends and a center of the composite leaf remain spaced apart from the main stage when the leaf spring assembly is in the second loading condition.

4. The leaf spring assembly of claim 1, wherein the composite leaf of the second stage has:
a first thickness at a center of the composite leaf; and
a second thickness at a distal end of the composite leaf, wherein the first thickness is greater than the second thickness.

5. The leaf spring assembly of claim 4, wherein the composite leaf of the second stage has:
a first cross-sectional area at the center of the composite leaf; and
a second cross-sectional area at the distal end of the composite leaf, wherein the first cross-sectional area and the second cross-sectional area are substantially equal.

6. The leaf spring assembly of claim 1, further comprising:
a plurality of end spacers disposed on distal ends of the second stage between the main stage and the second stage.

7. The leaf spring assembly of claim 6, further comprising:
a center spacer disposed between a center of the second stage and the main stage.

8. The leaf spring assembly of claim 7,
wherein the end spacers of the second stage are spaced apart from the main stage when the leaf spring assembly is in a first loading condition,
wherein the end spacers of the second stage are in contact with the main stage when the leaf spring assembly is in a second loading condition in which the main stage traveled toward the second stage by an engagement distance, and
wherein portions of the second stage between the distal ends and a center of the composite leaf remain spaced apart from the main stage when the leaf spring assembly is in the second loading condition.

9. The leaf spring assembly of claim 2, wherein the composite leaf of the second stage has:
a first thickness at a center of the composite leaf;
a second thickness at a distal end of the composite leaf, wherein the first thickness is greater than the second thickness;
a first cross-sectional area at the center of the composite leaf; and
a second cross-sectional area at the distal end of the composite leaf, wherein the first cross-sectional area and the second cross-sectional area are substantially equal.

10. A leaf spring assembly, comprising:
a main stage having at least two leaves, wherein the at least two leaves are steel leaves;
a second stage adjacent to the main stage and having:
a composite leaf having a concave curvature toward to the main stage, wherein the composite leaf is longitudinally aligned with the steel leaves of the main stage and is operatively attached to the main stage at a center of the composite leaf;
a first width at the center of the composite leaf; and
a second width at the distal ends of the composite leaf, wherein the second width is greater than the first width; and
a plurality of end spacers disposed on distal ends of the second stage between the main stage and the second stage, wherein the composite leaf of the second stage engages at the distal ends with the main stage.

11. The leaf spring assembly of claim 10, wherein the composite leaf of the second stage is formed from:
a resin matrix; and
a plurality of fibers, wherein the plurality of fibers are substantially longitudinally-oriented along the composite leaf.

12. The leaf spring assembly of claim 11, wherein the composite leaf of the second stage has:
a first cross-sectional area at the center of the composite leaf; and
a second cross-sectional area at the distal end of the composite leaf, wherein the first cross-sectional area and the second cross-sectional area are substantially equal.

13. The leaf spring assembly of claim 12, further comprising:
a center spacer disposed between a center of the second stage and the main stage.

14. A suspension assembly for a vehicle, comprising:
a main stage attached to the vehicle at a plurality of vehicle attachment points, wherein the main stage has at least one steel leaf;
a second stage attached to and adjacent to the main stage,
wherein the second stage has a composite leaf longitudinally aligned with the at least one steel leaf, and
wherein the composite leaf has a positive curvature relative to the main stage, such that distal ends of the composite leaf are nearer to the plurality of vehicle attachment points, in a direction of travel of the suspension assembly, than a center of the composite leaf.

15. The suspension assembly of claim 14, further comprising:
a plurality of end spacers disposed on distal ends of the composite leaf between the main stage and the second stage, wherein the second stage engages with the main stage at the plurality of end spacers before engaging at the center of the composite leaf of the second stage.

16. The suspension assembly of claim 15, wherein the composite leaf of the second stage has:
a first width at the center of the composite leaf; and
a second width the distal ends of the composite leaf, wherein the second width is greater than the first width.

17. The suspension assembly of claim 16, wherein the vehicle includes an axle, and further comprising:
a mounting apparatus configured to provide clamping force between the main stage, the second stage, and the axle, such that the mounting apparatus operatively attaches the axle to the suspension assembly; and
a load distribution spacer disposed between the axle and composite leaf, such that the load distribution spacer is compressed by the mounting apparatus.

18. The suspension assembly of claim 17, further comprising:
a center spacer disposed between a center of the second stage and the main stage.
